(19) United States
(12) Patent Application Publication
(10) Pub. No.: US 2003/0188320 A1
(43) Pub. Date: Oct. 2, 2003

(54) Method and system for a distributed digital video recorder

(75) Inventor: Honda Shing, Fremont, CA (US)

Correspondence Address: COUDERT BROTHERS LLP, Third Floor, 600 Beach Street, San Francisco, CA, 94109, US

(73) Assignee: Intervideo, Inc.

(21) Appl. No.: 10/115,843

(22) Filed: Apr. 2, 2002

(51) Int. Cl. H04N 7/173; H04N 7/16; G06F 15/16

(52) U.S. Cl. 725/131; 709/219; 725/139

(57) ABSTRACT

A system and method, for remote display and control of an audio/video data stream from a capture device, e.g., a TV capture card, audio/visual capture card or digital camera capture card in a PC. In an exemplary embodiment there are some components of a software DVR player executing on at least one client device and other components on at least one server device. Users can view and/or control the audio/video data from a server device, having a capture device, on client devices located anywhere as long as they are connected to the server through a network. In addition, a server device with a capture device can support display of the video data at multiple client devices at the same time.

### FIELD OF THE INVENTION

The invention relates generally to the field of computers, and in particular to a Digital Video Recorder software player on a computer.

### BACKGROUND OF THE INVENTION

The idea of a consumer watching a TV program whenever he/she wants to has been a major selling point for digital video recorders (DVRs). A hardware DVR is analogous to a VCR with a hard disk rather than a tape drive. A typical DVR hardware box is connected to the TV and stores about nine to 60 hours of TV programs. The price is on the expensive side and presently, there may be fewer than 500,000 DVR devices in consumer homes. Thus while the idea is good, the price is high and so far the demand is limited.

With the advent of fast CPU Personal Computers (PCs) with clocks speed near and above 500 MHz, and reasonably priced TV tuner cards, watching TV on a computer monitor using a software DVR player has a rapidly increasing audience. The software DVR player, such as WinDVR from InterVideo Inc. of Fremont, Calif. allows channel selection, playback, recording, replay, time-shifting, and other advanced features.

FIG. 1 is a block diagram of a prior art personal computer (PC) used for viewing a television (TV) program. The PC includes a TV capture card 120, a CPU 124, a memory 126, and a display interface 128. These components are connected together via an internal bus 122. The TV capture card 120 captures the audio and video data from a TV antenna 110, or a satellite dish (not shown) or cable TV connection (not shown) and sends the video data via the display interface 128 to the PC monitor 114 for viewing by the PC user. The audio data goes to a speaker.

FIG. 2 is a block diagram of a prior art software digital video recorder (DVR) player 208. The software DVR player 208 is stored in memory 126 of PC 112 and operated on by CPU 124. A graphical user interface (GUI) 210 receives commands from a user and responsive to those commands, controls the TV capture card 120 and some of the software modules of the DVR player 208 in order to, e.g., capture, playback, record, or time shift, the audio and video data provided by the TV capture card 120. A software audio capture driver 212 receives a TV program's audio data from the TV capture card 120. The audio capture driver 212 is connected to an audio encoder 214 which encodes the audio data. A software video capture driver 216 receives a TV program's video data stream from the TV capture card 120. The video data is then encoded by video encoder 218. The encoded audio and video are merged together via multiplexer 220. The multiplexed audio/video data is then, in parallel, sent to a time shifter module 222 and a program recording module 224. The time shifter module 222 includes a memory, such as a buffer, for time shifting the multiplexed audio/video data. The program recording module includes another memory, such as a hard disk, for storing the multiplexed audio/video data for later playback. The multiplexed audio/video data after being time shifted, including a time shift of zero, or after being recorded, has the audio data separated from the video data by demultiplexer 226. Audio decoder 230 decodes the encoded audio data from the demultiplexer 226. The decoded audio data is then sent to an audio renderer 232 for output to a speaker system. The encoded video data from the demultiplexer 226 is then decoded by video decoder 234, and then sent for display via video renderer 236.

While the software DVR player has allowed the use of a PC to perform the functions of a hardware DVR player, there are several limitations to the conventional software DVR player technology. First, the capture device and multimedia contents can only be controlled on the device, e.g., computer, with the capture device, this includes the playback of the captured contents. Hence, other devices on the same network with this device cannot control the capture device nor playback the multimedia contents captured by the device. Second, only one DVR can playback, record, or time-shift the content from a capture device at a time. Multiple DVR sessions running on different devices cannot playback, record, or time-shift the content from the same capture device at the same time.

Thus there is a need for techniques that allow better use of the TV or video/audio capture resources, without requiring each computer or device to have a TV capture or audio/video capture card in order to view the TV or audio/video data.

### SUMMARY OF THE INVENTION

The present invention provides techniques, including a system and method, for remote display and control of an audio/video data stream from a capture device, e.g., a TV capture card, audio/visual capture card or digital camera capture card in a PC. In an exemplary embodiment of the present invention there are some components of a software DVR player executing on at least one client device and other components on at least one server device. The commands for the software DVR player, as well as the audio/video data are transferred between clients and servers. Thus users can view and/or control the audio/video data captured by a server device, using a capture device, on client devices (without any capture devices) located anywhere as long as they are connected to the server through a network. In addition, a server device with a capture device can support display of the video data at multiple client devices at the same time. When the server devices have both the server and client components of the software DVR player, a first server device may exchange audio/video data with a second server device, where the first server device is a client of the second server device and the second server device is a client of the first server device.

One embodiment of the present invention includes a method for a first device remotely displaying video data provided by a capture device at a second device. First, encoded video data, from the second device is received, where the video data is provided by the capture device and encoded by said second device. The capture device may include one of the following: TV capture card, a digital camera (still or video) capture card, or an audio/video capture card. The encoded video data is received and decoded by the first device. Lastly, the video data is processed for display at the first device. In an alternative embodiment the encoded video data is received and stored in memory by the first device, where the encoded video data may be time shifted or recorded.

Another embodiment of the present invention includes a method for providing video data from a first device, including a TV or video capture card, to a second device, including a GUI remote control. First, a command is received from the GUI remote control. Responsive to the command, capturing video data from the TV or video capture card and then sending the captured video data to the second device.

Yet another embodiment of the present invention includes a server computer system, including a video capture module, for sending video data from the video capture module to a client computer. The server computer system includes: a remote command handler for receiving a command from a graphical user interface displayed at the client computer and controlling the video data from the video capture module; a video encoder for encoding the video data; a time shift module for time shifting the encoded video data; and a multicast module for sending the encoded video data to the client computer via a communications network.

An further embodiment of the present invention includes a client system for remotely displaying a video data stream from a server computer, the client system connected to the server computer via a communications network. The client system includes: a network interface module for sending commands and for receiving the video data stream from the server computer; a memory module connected to the network interface module for time shifting the video data stream; a decoder connected to the memory module for decoding the video data stream; and a display for displaying the decoded video data stream.

Another embodiment of the present invention includes a system for providing server and client functions for playback of video data. The peer to peer system includes: a memory for storing the video data by a local client or a remote client; a remote command handler for receiving commands from the remote client; a network interface for receiving video data from the remote server; and a multicast module for sending video data to one or more remote clients.

An embodiment of the present invention provides a home networking system for a user remotely playing back video data on a display, including: a server computer including a TV or video capture card for capturing the video data; a client device including a decoder for decoding the video data for the display; and a home networking device connecting the server computer to the client device.

An aspect of the present invention includes a method for displaying a portion of a TV program received by a first computer at a second computer, where the first computer is coupled to the second computer by a network. First, a selection is made from a graphic displayed at the second computer of the portion of the TV program from a plurality of TV programs received by the first computer. The portion is received, time shifted and displayed at the second computer

Another aspect of the present invention includes a method for displaying a portion of a TV program received by a first computer at a second computer, where the first computer is coupled to the second computer by a network. First, a selection is made from a graphic displayed at the second computer of the portion of the TV program from a plurality of TV programs received by the first computer. The portion is received, saved in memory, and displayed at the second computer.

Another embodiment of the present invention includes a home networking system for a user viewing video data on a display. The system includes:, a first system, comprising a processor and a memory, for sending said video data; a thin client for receiving said video data, comprising a decoder for decoding said video data for said display; and a wireless network for connecting said first system to said thin client.

These and other embodiments, features, aspects and advantages of the invention will become better understood with regard to the following description, appended claims and accompanying drawings.

### BRIEF DESCRIPTION OF THE DRAWINGS

FIG. 1 is a block diagram of a prior art personal computer (PC) used for viewing a television (TV) program;

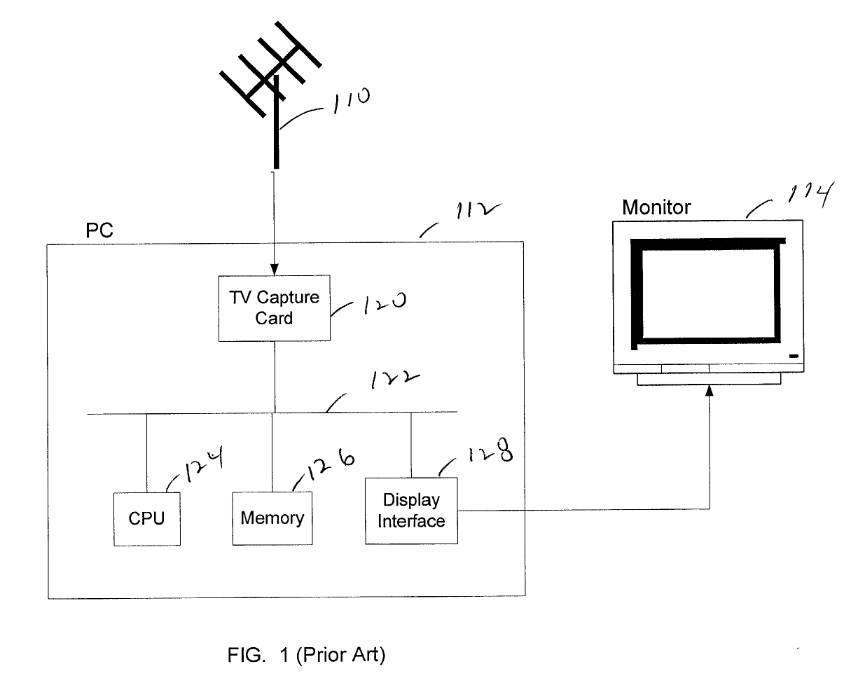

FIG. 2 is a block diagram of a prior art software digital video recorder (DVR) player;

FIG. 3 is an example of a window showing video data, e.g., a baseball game, on a display screen of an aspect of the present invention;

FIG. 4 has an example of a remote GUI used for control of a software DVR player of an aspect of the present invention;

FIG. 5 is a network diagram of a client-server system of one embodiment of the present invention;

FIG. 6 is a block diagram of a DVR client system of an embodiment of the present invention;

FIG. 7 is a block diagram of a DVR server of an embodiment of the present invention;

FIG. 8 is a block diagram of the exchange of commands and data between a client and a server of an embodiment of the present intention;

FIG. 9 is a block diagram of a peer-to-peer DVR system of an embodiment of the present invention;

FIG. 10 is a diagram of an example home networking system in which the video data stream from one TV capture card is shared by multiple users in the home of an embodiment of the present invention; and

FIG. 11 is a diagram of an example home networking system in which the audio/video data stream from one TV capture card is shared by multiple users over a wireless LAN of another embodiment of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

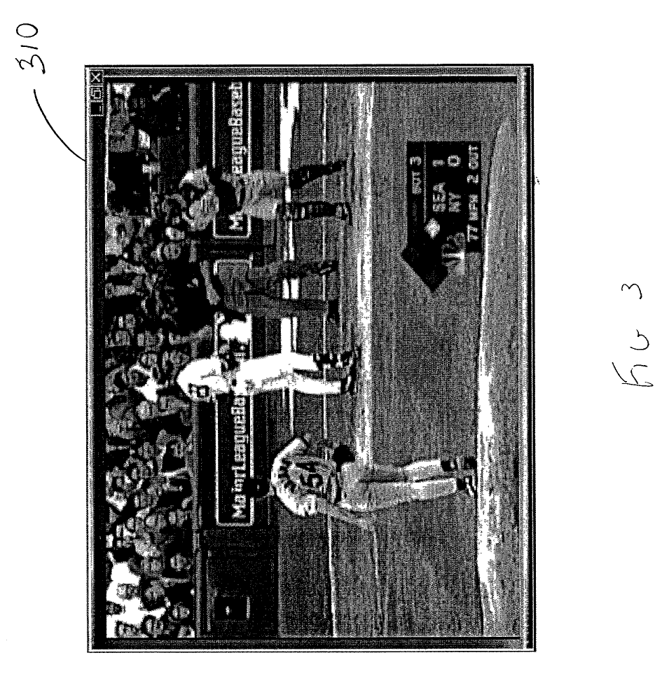

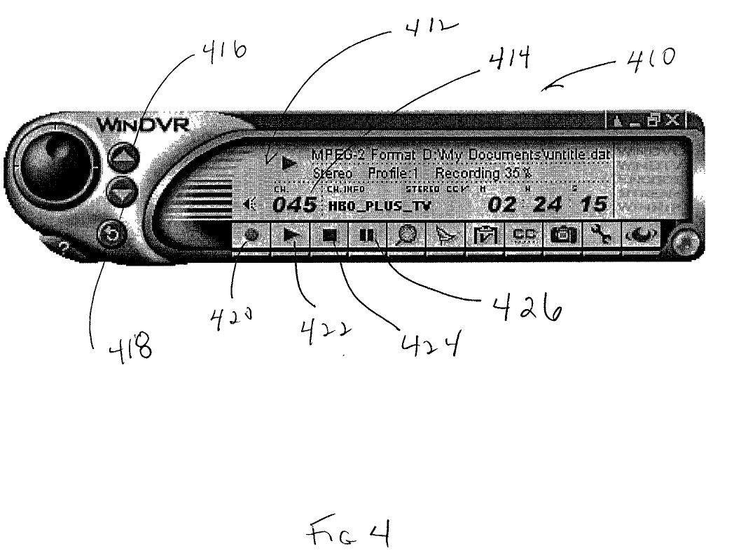

FIG. 3 is an example of a window 310 showing video data, e.g., a baseball game, on a display screen of an aspect of the present invention. The window 310 may be shown on the server's or the client's or both displays. The display of the video data is controlled by the user via a graphical user interface (GUI) shown in FIG. 4.

FIG. 4 has an example of a remote GUI 410 used for control of a software DVR player of an aspect of the present invention. The GUI includes buttons to control capturing, recording, playback, and time shifting of the audio/video data received from a TV antenna, cable TV connection, satellite dish, digital camera, and the like. The GUI controls the TV capture card for channel selection using, for example, icons 416 and 418 where the channel selected is shown in window 412, e.g., “CH. 045” 414. There are record 420, play 422, stop 424, and pause 426 control buttons for program recording, playback, and time shifting.

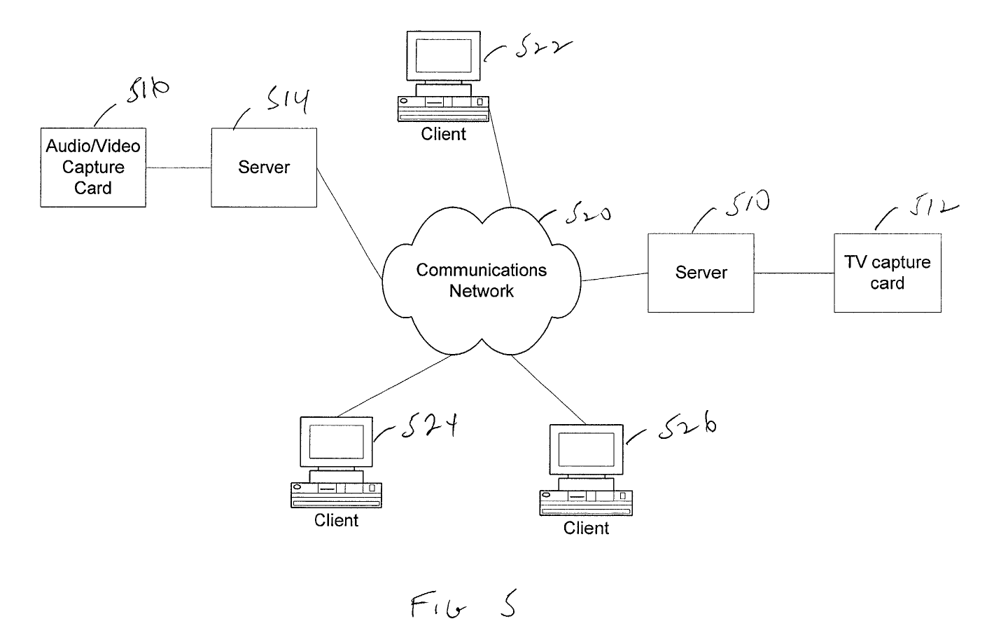

FIG. 5 is a network diagram of a client-server system of one embodiment of the present invention. A server computer or server, includes a capture device, for example, server 510 has TV capture card 512 and server 514 has an audio/video capture card 516. The servers are connected to a communications network 520 which also connects them to one or more client computers, for example, client computers 522, 524, and 526. Conventionally a server receives audio/video data only on its own capture device. The present invention not only allows one or more clients to receive audio/video data from one or more servers, but allows a server, e.g., server 510, to receive audio/video data from another server, e.g., server 514 and vice versa. The major difference between a server computer and a client computer or device is that a server computer includes at least one capture device for capturing audio and/or video data from, e.g., a TV antenna, Cable TV connection, internet connection, satellite dish, telephone connection, digital camera (still or video) or wireless connection.

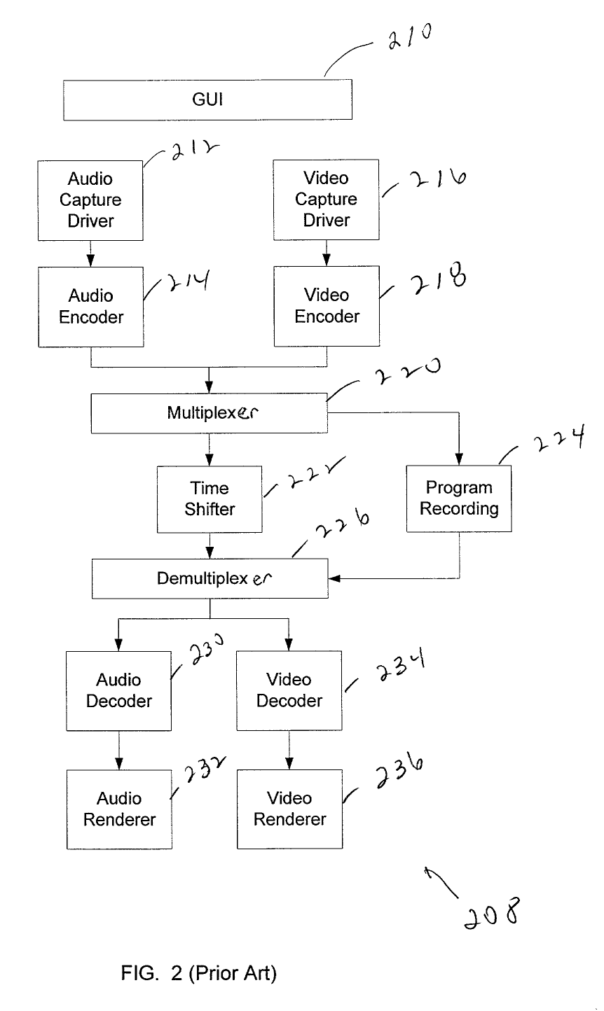

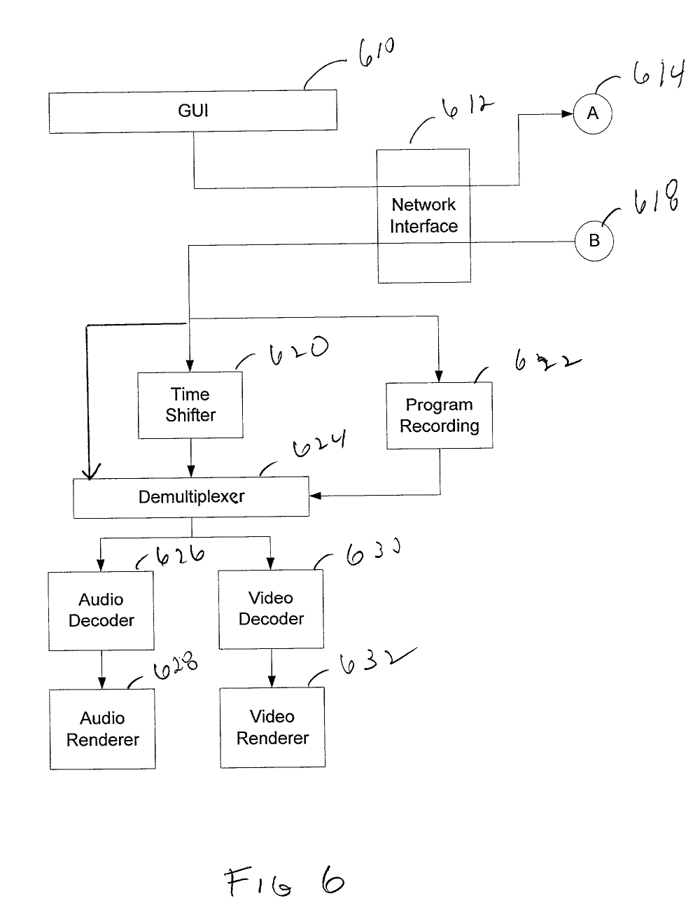

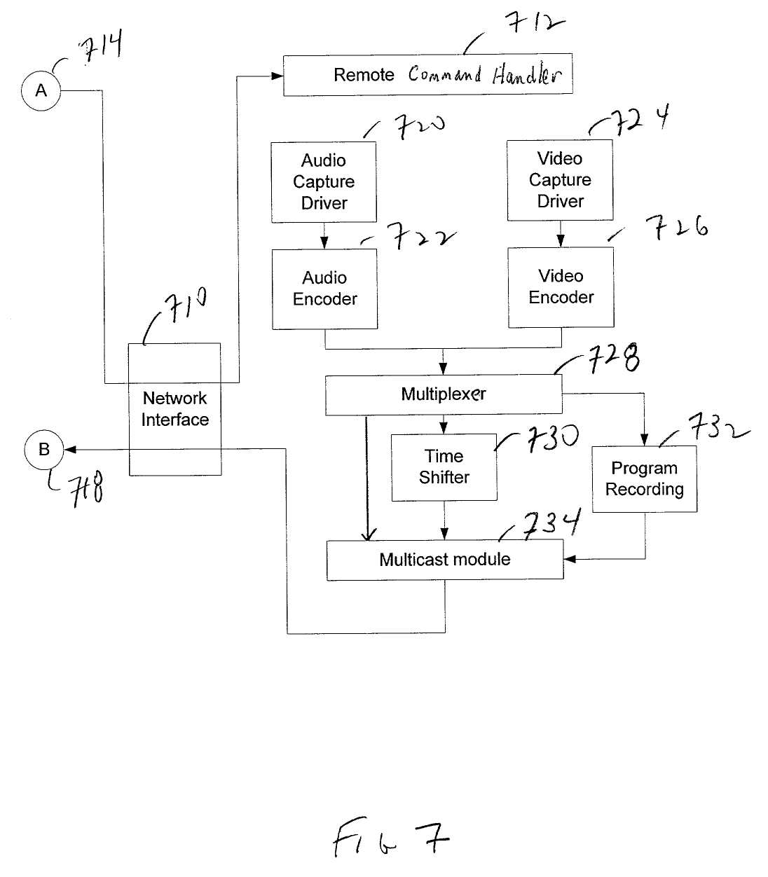

FIG. 6 is a block diagram of a DVR client system of an embodiment of the present invention. Since the software DVR player of FIG. 2 includes a plurality of software modules, a first group of these modules is duplicated on the client computer system (FIG. 6) with a second group duplicated on the server computer system (FIG. 7). There is a time shifter module and a program recording module on both the client and the server computer systems. Thus a server can time shift or record the audio/video data for the one or more clients the server is multicasting to via time shifter module 730 or program recording module 732, respectively (FIG. 7). Or each client can do individual time shifting or recording via time shifter module 620 or program recording module 622. Client-side time-shifting is convenient when multiple clients of the same server have different time-shifting factors, while server-side time-shifting may be needed, for example, when there is no hard disc or limited memory on some of the clients. Thus for a diskless or low memory client, the time-shifter module 620 and/or the program recording module 622 may be absent and the diskless client has its audio/video data time shifted and/or recorded by the server's time shifter module 730 and/or program recording module 732. In another embodiment, when a TV capture card can simultaneously capture different TV channels or there could be a plurality of TV capture cards in the server, then a first client can time shift or record a first TV channel, while a second client time shifts or records a second TV channel.

A graphical user interface (GUI) 610 receives user selections and sends GUI commands to the network interface 612. The GUI has a display similar to FIG. 4 and may have additional buttons to control both the client's and server's time shifter and program recording modules, e.g., two record and pause buttons. The GUI is generated at the client and includes control icons that are generated by the client computer independently from any data received from the server computer.

The GUI commands go via node A 614 through a communications network 520 to node A 714 on FIG. 7 and hence to the remote command handler 712 (FIG. 7) on the server computer. The GUI commands control the capture device on the server and some of the software modules on both the client (FIG. 6) and server (FIG. 7) for manipulation of the audio/video data from the capture device, for example, recording, playback, or time shifting.

In an embodiment of the present invention the GUI commands have the following message format:

struct CommandMessage

{
struct sockaddr_in client_addr;
enum CSESSIONcmd command_code;
unsigned short datalen;
unsigned char data[COMMAND_DATA_LEN];
};

The “data” field contains command-specific data, which may be in different formats for command messages of different command codes.

An enumeration of the command codes is as follows:

enum CSESSIONcmd

{

SESSION_CMD_Open,
SESSION_CMD_Close,
SESSION_CMD_Record,
SESSION_CMD_Play,
SESSION_CMD_Step,
SESSION_CMD_Pause_On,
SESSION_CMD_Pause_Off,
SESSION_CMD_Stop,
SESSION_CMD_ChannelUp,
SESSION_CMD_ChannelDown,
SESSION_CMD_LastChannel,
SESSION_CMD_GotoChannel,
SESSION_CMD_FastBackward,
SESSION_CMD_FastForward,
SESSION_CMD_CloseCaption,
SESSION_CMD_GetProperty,
SESSION_CMD_SetProperty

};

In response to the above GUI commands the remote command handler 712 may respond with a response message. For example, in response to the SESSION_CMD_ChannelUp GUI command the response includes data (data[COMMAND_DATA_LEN]) to display the selected channel, e.g., “CH. 045” 414 on FIG. 4. The response message sent from the remote command handler 712 to the GUI 610 has the following message format:

struct ResponseMessage

{
int response_code;
unsigned short datalen;
unsigned char data[COMMAND_DATA_LEN];
};

The multiplexed audio/video data at the network interface 612 is received from the multicast module 734 (FIG. 7) via node B 618 via communications network 520 via node B 718 via network interface 710. The multiplexed audio/video data is sent in parallel to time shifter module 620, program recording module 622 or directly to demultiplexer 624. The output of time shifter module 620 and program recording module 622 is sent to demultiplexer 624 which separates the audio data from the video data. The audio data is then decoded by audio decoder 626 and sent via audio renderer 628 to a speaker system. The video data its decoded by video decoder 630 and sent via a video renderer 632 to a display system for display.

The time shifter module 620 includes a memory such as a buffer so that the multiplexed audio/video data may be delayed. The buffer may or may not include a hard disk. For example, when a user presses the pause button 426 (FIG. 4), the incoming audio/video data is stored in time shifter module 620, i.e., it is queued in a First-In-First-Out (FIFO) buffer, until the user unpauses. Then this audio/video data is taken out of the FIFO and sent to the demultiplexer 624. At the same time new audio/video data from the network interface 612 is being input into the FIFO at the end of the queue. Thus in effect the user continues to view the, e.g., TV program, as if there was no pause, because the audio/video data has been time shifted, i.e., delayed to account for the pause period.

The program recording module 622 includes a memory such as a hard disk for storing the audio/video data for playback at a later time. The program recording module 622 functions like a tape in a VCR except it is stored in a computer memory or disk. A user can record only those portions of a TV program which he/she is interested in.

FIG. 7 is a block diagram of a DVR server of an embodiment of the present invention. Remote command handler 712 receives user commands from GUI 610 via network interface module 710, node A 714, communications network 520, node A 614, and network interface 612. The remote command handler 712 controls the capture device on the server computer, and some software modules, e.g., the time shifter module 730 and program recording module 732. The remote command hander performs the functions of capturing, recording, playback, and time shifting of the audio/video data coming from the video capture module (not shown), responsive to the commands from the GUI 610. The audio data from the capture device is sent to software audio encoder 722 for encoding via a software audio capture driver 720. The video data from the capture device is sent to software video encoder 726 for encoding, for example encoding in MPEG-2, via the software video capture driver 724. The output of the audio encoder 722 and video encoder 726 are then combined together by multiplexer 728 to form the multiplexed audio/video data, which is then sent to the time shifter module 730, program recording module 732, or directly to multicast module 734. The time shifter module 730 time shifts the audio/video data for all the multicast clients (via multicast module 734) of the server. The program recording module 732 records a program for all the multicast clients (via multicast module 734), of the server. The output from the time shifter module 730 or the program recording module 732 is then input into the multicast module 734 for multicasting to one or more clients via network interface module 710, node B 718, and communications network 520.

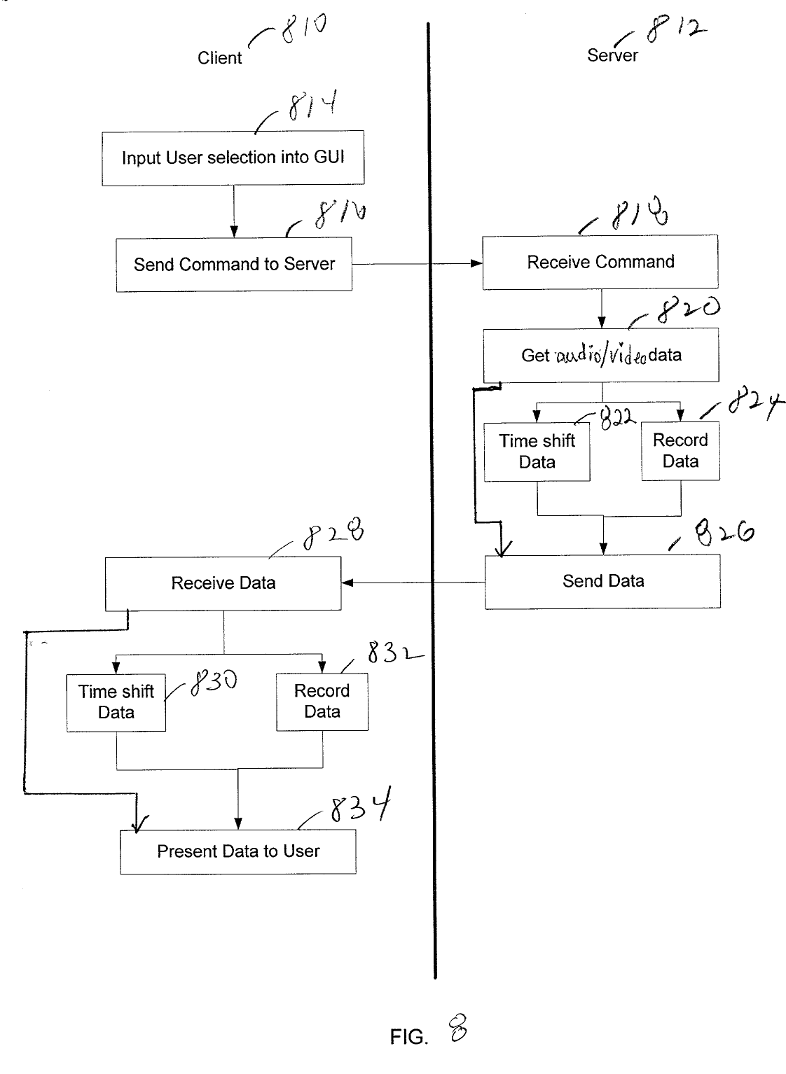

FIG. 8 is a block diagram of the exchange of commands and data between a client 810 and a server 812 of an embodiment of the present invention. At step 814 the user inputs his/her selection into the GUI at client 810. At step 816 the client 810 sends the command to the server 812 via a communications network 520. The server 812, at step 818, receives the command and gets the audio/video data from the capture device. The server in getting the audio/video data performs the sub-steps including: encoding the audio and video data, and multiplexing the audio and video data. The multiplexed audio/video data is either time shifted at step 822, recorded at step 824, or sent directly to step 826. Next, at step 826, the data is sent by the server 812 to the client 810. The client 810, which may be one of many clients, receives the data (step 828) and may further time shift 830 the data, record 832 the data, or send the data directly to step 834. The data is then presented to the user for viewing (step 834).

Another embodiment of the present invention is a “peer-to-peer” approach, which allows a computer system to be both a client DVR and a server DVR. The peer-to-peer software is basically a combination of both the client side (FIG. 6) and the server side software (FIG. 7). The peer-to-peer software can switch between standalone, client, and server modes at run-time. When it is in client mode, it sends GUI commands to a remote server and receives audio/video data from that remote server. Upon request by a remote client, it can switch to server mode and begin sending audio/video data from its local capture device to the remote client.

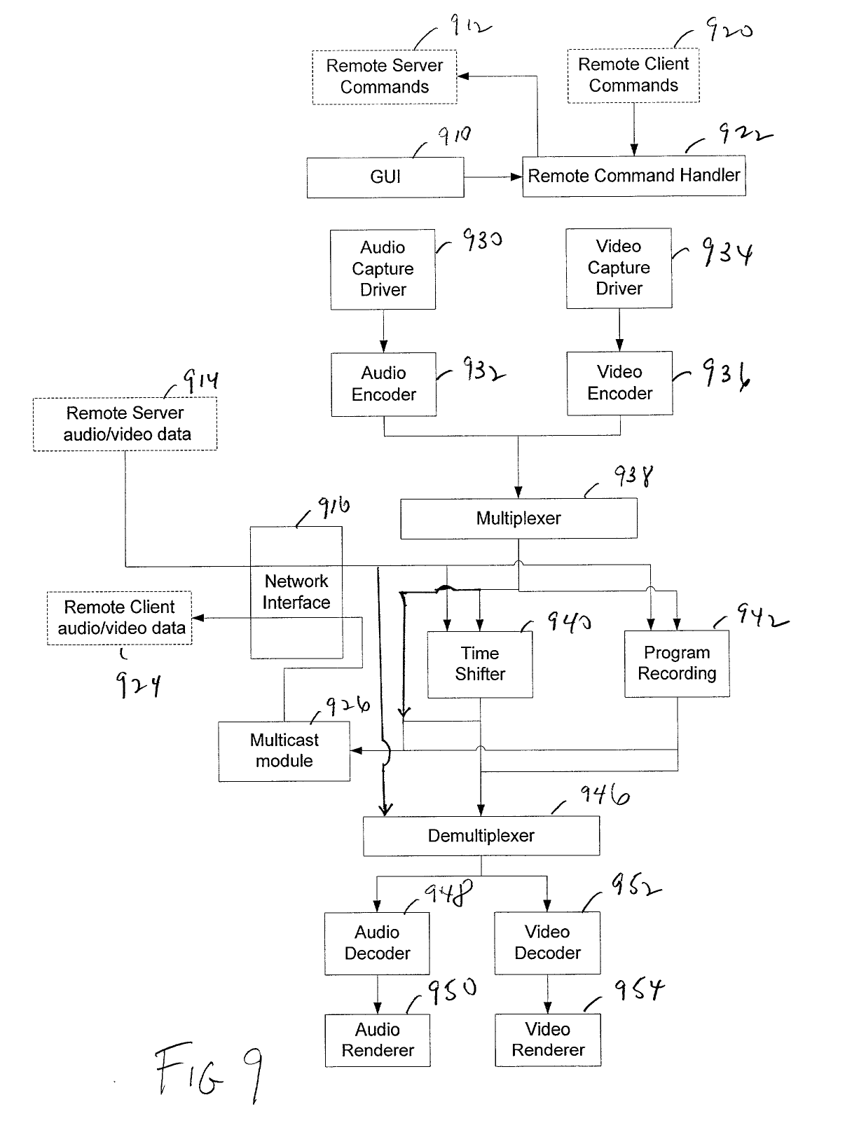

FIG. 9 is a block diagram of a peer-to-peer DVR system of an embodiment of the present invention. In FIG. 9 the computer has both the server software and the client software. FIG. 9 shows two modes: the server mode and the client mode. The remote command handler 922, depending on the mode, either delivers local user GUI commands to a remote server or receives and handles GUI commands from a remote client. In client mode, GUI 910 sends commands to remote server 912 via the remote command handler 922. In server mode, commands from a remote client 920 are received by the remote command handler 922. Responsive to the remote server commands 912, the remote server sends remote server audio/video data 914 to the time shifter module 940, the program recording module 942, or directly to demultiplexer 946 via network interface 916. Responsive to commands from the remote client 920, remote command handler 922 sends the remote client audio/video data 924 from the time shifter module 940 or the program recording module 942 via multicast module 926 and network interface module 916. In server or standalone mode, the audio data from the capture device (not shown) is sent, via audio capture driver 930, to audio encoder 932 for encoding, e.g., using MP3. Similarly the video data from the capture device (not shown) is sent, via video capture driver 934, to video encoder 936 for encoding, e.g., using MPEG-2. The encoded audio and video data is then combined via multiplexer 938, and the multiplexed audio/video data is sent to time shifter module 940, programming recording module 942, or directly to multicast module 926. The output of time shifter module 940 or programming recording module 942 is then sent to the multicast module 926 and/or demultiplexer 946. In all modes, when demultiplexer module 946 receives the multiplexed audio/video data, the data is then separated into audio data which goes to audio decoder 948 and audio renderer 950, and video data which goes to video decoder 952 and video renderer 954.

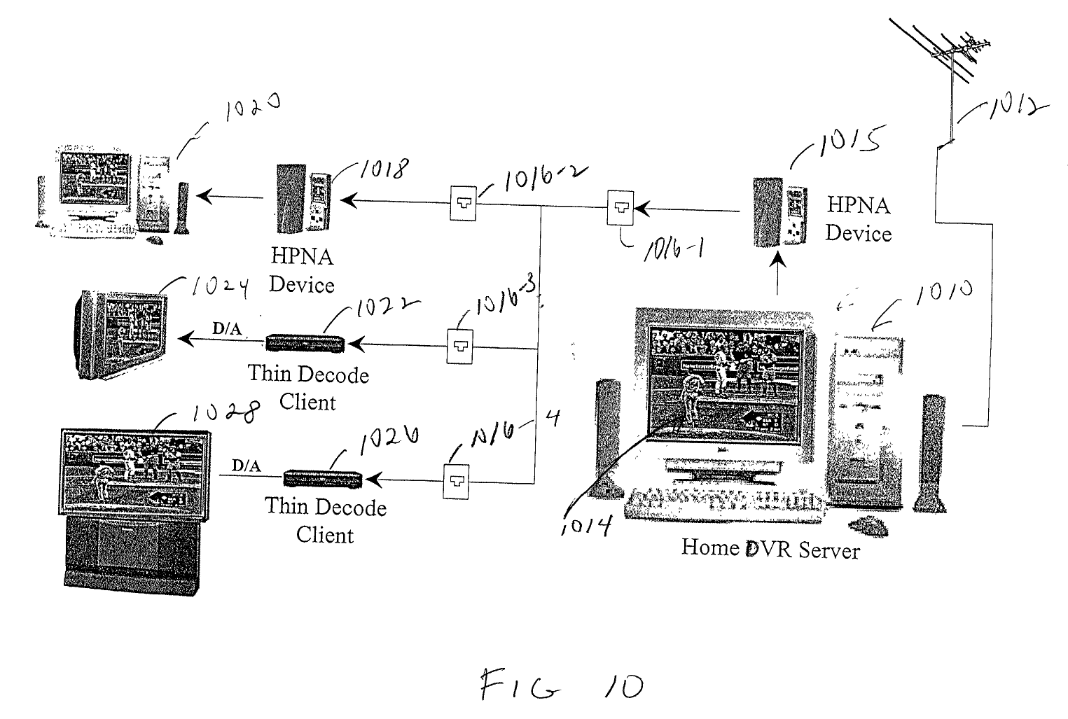

FIG. 10 is a diagram of an example home networking system in which the audio/video data stream from one TV capture card is shared by multiple users in the home of an embodiment of the present invention. A home DVR server 1010 has a TV capture card (not shown) which receives the audio/video data stream from a receiving device, e.g., an antenna 1012, a satellite dish, or a cable TV connection. The user at the home DVR server 1010 may view the video data stream on a display 1014. The home DVR server 1010 is connected to a HPNA device 1015, where HPNA is Home Phoneline Networking Alliance, an industry standard for interconnecting computers within a home using existing telephone lines and registered jacks, e.g. 1016-1, 1016-2, 1016-3, and 1016-4. HPNA device 1015 is connected to HPNA device 1018, and hence couples server computer 1010 (FIG. 7 or FIG. 9) to client computer 1020 (FIG. 6 or FIG. 9). A thin decode client, e.g., 1022 or 1026, that includes some of the software modules of the client in FIG. 6, can receive the video data stream from the home DVR server 1010 and display the video data stream on, for example, a TV 1024 or home theater 1028. When home DVR server 1010 has both client and server software, one option is that the TV capture card is controlled from the home DVR server 1010 and multicast to the other devices, e.g., client computer 1020, TV 1024, and home theater 1028. Another option has client 1020 controlling the TV capture card on the home DVR server 1010. Other options include various combinations of client and server software (FIGS. 6, 7, and 9) at the home DVR server 1010, the client computer 1020, and the thin decode clients 1022 and 1026.

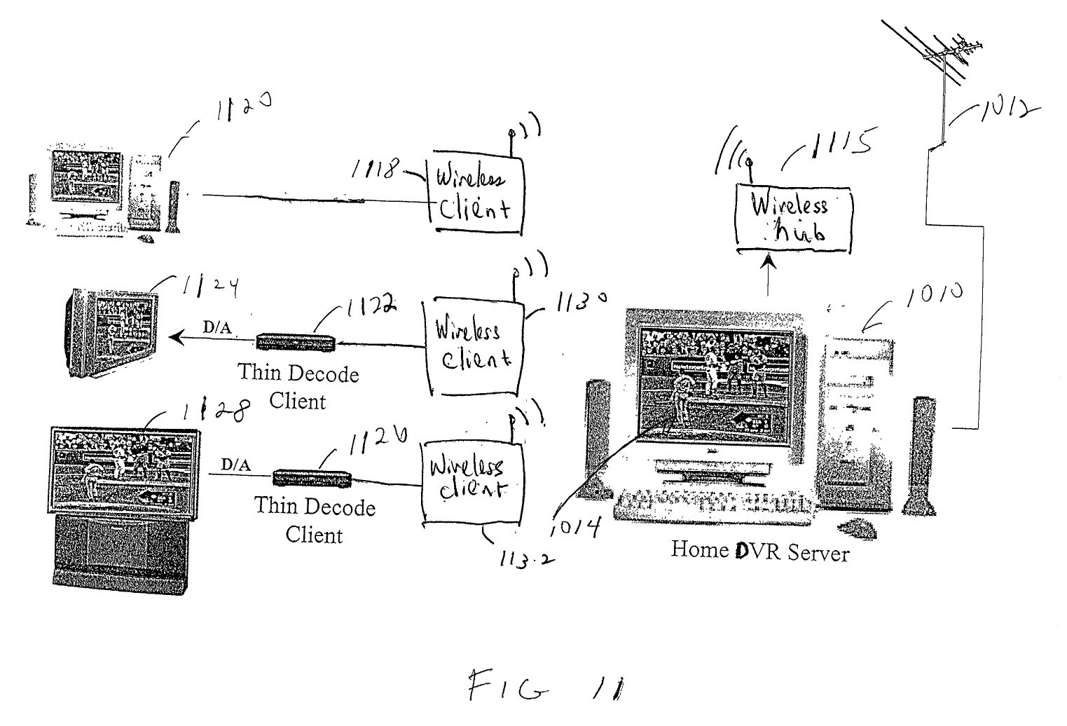

FIG. 11 is a diagram of an example home networking system in which the audio/video data stream from one TV capture card is shared by multiple users over a wireless LAN of another embodiment of the present invention. A home DVR server 1010 has a TV capture card (not shown) which receives the audio/video data stream from a receiving device, e.g., an antenna 1012, a satellite dish, or a cable TV connection. The user at the home DVR server 1010 may view the video data stream on a display 1014. The home DVR server 1010 is connected to a wireless hub 1115, as part of a wireless local area network (LAN). The wireless hub 1115 is connected to wireless client device 1118, which may be a wireless LAN card in PC 1120, and couples server computer 1010 (FIG. 7 or FIG. 9) to client PC 1120 (FIG. 6 or FIG. 9). A thin decode client, e.g., 1122 or 1126, that includes some of the software modules of the client in FIG. 6, can receive the video data stream from the home DVR server 1010 and display the video data stream on, for example, a TV 1124 or home theater 1128. The thin decode clients receive the video via the wireless LAN clients 1130 and 1132, where a wireless LAN client includes a wireless LAN transceiver device. When home DVR server 1010 has both client and server software, one option is that the TV capture card is controlled from the home DVR server 1010 and multicast to the other devices, e.g., client computer 1120, TV 1124, and home theater 1128. Another option has client 1120 controlling the TV capture card on the home DVR server 1010. Other options include various combinations of client and server software (FIGS. 6, 7, and 9) at the home DVR server 1010, the client computer 1120, and the thin decode clients 1122 and 1126.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the invention has been described using a particular series of transactions and steps, it should be apparent to those skilled in the art that the scope of the invention is not limited to the described series of transactions and steps.

Further, while the invention has been described using a particular combination of hardware and software, it should be recognized that other combinations of hardware and software are also within the scope of the invention. The invention may be implemented only in hardware or only in software or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method for a first device displaying video data provided by a capture device at a second device, said method comprising:
receiving encoded video data, from said second device, said video data provided by said capture device and encoded by said second device;
decoding said encoded video data by said first device; and
processing said video data for display at said first device.

2. The method of claim 1 wherein said capture device is selected from a group consisting of a TV capture card, a digital camera capture card, and an audio/video capture card.

3. The method of claim 1 further comprising time shifting said encoded video data.

4. A method for a first device displaying video data provided by a capture device at a second device said method comprising:
receiving encoded video data from said second device, wherein said video data is captured by said capture device and encoded by said second device;
storing said encoded video data in a memory;
decoding said encoded video data by said first device; and
processing said video data for display at said first device.

5. The method of claim 4 wherein said capture device is selected from a group consisting of a TV capture card, a digital camera capture card, and an audio/video capture card.

6. The method of claim 4 wherein said storing comprises time shifting said video data.

7. The method of claim 6 further comprising demultiplexing said time shifted video data.

8. The method of claim 4 wherein said storing comprises recording said video data.

9. The method of claim 8 further comprising demultiplexing said recorded video data.

10. The method of claim 4 further comprising sending a user command from a graphical user interface at said first device to a remote command handler operating on said second device.

11. A method for providing video data from a first device, comprising a TV or video capture card, to a second device, comprising a GUI remote control, said method comprising:
receiving a command from said GUI remote control;
responsive to said command, capturing an video data from said TV or video capture card; and
sending said captured video data to said second device for display.

12. The method of claim 11 further comprising time shifting said video data.

13. The method of claim 11 further comprising recording said video data.

14. The method of claim 11 wherein said GUI remote control comprises a predetermined graphic comprising predetermined selection buttons.

15. The method of claim 11 further comprising multiplexing said video data with audio data.

16. The method of claim 11 further comprising sending said video data to a third device.

17. A server computer system, comprising a video capture module, for sending video data from said video capture module to a client computer, comprising:
a remote command handler for receiving a command from a graphical user interface displayed at said client computer and controlling said video data from said video capture module;
a video encoder for encoding said video data;
a time shift module for time shifting said encoded video data; and
a multicast module for sending said encoded video data to said client computer via a communications network.

18. The system of claim 17 wherein said video capture module is selected from a group consisting of a TV capture card, a video capture card, and a audio/video capture card.

19. The system of claim 17 further comprising recording said encoded video data in a memory.

20. The system of claim 19 wherein said memory includes a hard disk.

21. The system of claim 17 wherein said multicast module sends said encoded video data to another client computer via said communications network.

22. A client system for remotely displaying a video data stream from a server computer, said client system connected to said server computer via a communications network, comprising:
a network interface module for receiving said video data stream from said server computer;
a memory module connected to said network interface module for time shifting said video data stream;
a decoder connected to said memory module for decoding said video data stream; and
a display for displaying said decoded video data stream.

23. The client system of claim 22 further comprising:
a graphical user interface shown on a display for receiving a command from a user.

24. The client system of claim 22 further comprising: another memory module connected to said network interface module for recording said data stream.

25. A system for providing server and client functions for playback of video data, comprising:
a memory for storing playback of said video data by a local client or a remote client;
a remote command handler for receiving commands from said remote client;
a network interface for receiving video data from said remote server; and
a multicast module for sending video data to one or more remote clients.

26. A home networking system for a user remotely viewing video data on a display, comprising:
a server computer comprising a TV or video capture card for capturing said video data;
a remote device comprising a decoder for decoding said video data for said display; and
a networking device connecting said server computer to said remote device.

27. The system of claim 26 wherein said networking device is a wireless network hub.

28. The system of claim 26 wherein said networking device is a Home Phoneline Networking Alliance (HPNA) device.

29. The system of claim 26 wherein said networking device is an Ethernet device.

30. The system of claim 26 wherein said remote device further comprises a memory for time shifting said video data.

31. A home networking system for a user viewing video data on a display, comprising:
a first system, comprising a processor and a memory, for sending said video data;
a thin client for receiving said video data, comprising a decoder for decoding said video data for said display; and
a wireless network for connecting said first system to said thin client.

32. A method for displaying a portion of a TV program received by a first computer at a second computer, said first computer coupled to said second computer by a network, said method comprising:
selecting from a graphic displayed at said second computer, said portion of said TV program from a plurality of TV programs received by said first computer;
receiving at said second computer said portion;
time shifting said portion by said second computer; and
displaying said portion.

33. The method of claim 32 wherein said graphic comprises a plurality of icons generated independently from said first computer.

34. The method of claim 32 further comprising time shifting said portion by said first computer.

35. The method of claim 32 further comprising recording said portion by said first computer.

36. The method of claim 32 further comprising time shifting said portion by said second computer.

37. The method of claim 32 further comprising recording said portion by said second computer.

38. A method for displaying a portion of a TV program captured by a first computer at a second computer, said first computer coupled to said second computer by a network, said method comprising:
selecting from a graphic displayed at said second computer, said portion of said TV program from a plurality of TV programs captured by said first computer;
receiving at said second computer said portion; and
displaying said portion.

39. The method of claim 38 further comprising saving said portion in a memory on said second computer.

40. A computer program product stored on a computer readable medium for a first computer remotely displaying video data provided by a capture device in a second computer said method comprising:
code for receiving encoded video data, from said second computer, said video data provided by said capture device and encoded by said second computer;
code for storing said encoded video data in a memory;
code for decoding said encoded video data by said first computer; and
code for processing said decoded video data for display at said first computer.
